(19) United States
(12) Patent Application Publication
(10) Pub. No.: US 2011/0117787 A1
(43) Pub. Date: May 19, 2011

(54) USB CONNECTOR

(76) Inventors: Chung-Won Shu, Taipei City (TW); Chih-Heng Chiu, Taipei City (TW); Tsang-Yi Chen, Taipei County (TW); Yung-Fa Huang, Hsinchu City (TW)

(21) Appl. No.: 12/639,002

(22) Filed: Dec. 16, 2009

(30) Foreign Application Priority Data
Nov. 18, 2009 (TW) 098139120

(51) Int. Cl. H01R 24/00

(52) U.S. Cl. 439/660

(57) ABSTRACT

A USB connector is adapted to a USB receptacle in compliance with two different USB standards including a first USB standard and a second USB standard. The USB connector includes a first USB plug and a second USB plug. The first USB plug is in compliance with the first USB standard, and the second USB plug integrated with the first USB plug is in compliance with the second USB standard. The second USB plug is detachably connected to the first USB plug.

### BACKGROUND OF THE INVENTION

1. Field of the Invention

The preferred embodiment relates to a universal serial bus (USB) connector and, more particularly, to a USB connector with detachable USB plugs.

2. Description of the Prior Art

Nowadays, USB is the most popular peripheral bus in computer industry and consumer electronic products. USB can be used to connect various peripheral devices, such as keyboard, mouse, flash driver, card reader, digital camera, personal digital assistant (PDA), smart phone, and so on. Due to plug and play capability and usage convenience, USB is available to most of applications in the market. So far there are lots of USB applications developed by peripheral and computer manufactures and there are also lots of drivers and programs developed correspondingly.

At present, a data transmission rate of USB 2.0 is 480 Mbps, and a data transmission rate of USB 3.0 is 5 Gbps, which is five times that of USB 2.0. Compared with USB 2.0, USB 3.0 may save much power. Furthermore, USB 3.0 is compatible with USB 2.0. Referring to table 1 in the following, table 1 shows various relations between USB 2.0/3.0 plugs and receptacles.

TABLE 1

| Type | Receptacle | Plug |
|---|---|---|
| 1 | USB 2.0 standard-A | USB 2.0 standard-A or |
| | | USB 3.0 standard-A |
| 2 | USB 3.0 standard-A | USB 3.0 standard-A or |
| | | USB 2.0 standard-A |
| 3 | USB 2.0 standard-B | USB 2.0 standard-B |
| 4 | USB 3.0 standard-B | USB 3.0 standard-B or |
| | | USB 2.0 standard-B |
| 5 | USB 3.0 powered-B | USB 3.0 powered-B, |
| | | USB 3.0 standard-B or |
| | | USB 2.0 standard-B |
| 6 | USB 2.0 micro-B | USB 2.0 micro-B |
| 7 | USB 3.0 micro-B | USB 3.0 micro-B or |
| | | USB 2.0 micro-B |
| 8 | USB 2.0 micro-AB | USB 2.0 micro-B or |
| | | USB 2.0 micro-A |
| 9 | USB 3.0 micro-AB | USB 3.0 micro-B, |
| | | USB 3.0 micro-A, |
| | | USB 2.0 micro-B or |
| | | USB 2.0 micro-A |

As shown in table 1, in type 3, USB 2.0 standard-B receptacle only can be connected to USB 2.0 standard-B plug; in type 6, USB 2.0 micro-B receptacle only can be connected to USB 2.0 micro-B plug; and in type 8, USB 2.0 micro-AB receptacle only can be connected to USB 2.0 micro-B or micro-A plug.

Referring to FIG. 1, FIG. 1 is a schematic diagram illustrating a conventional USB 3.0 standard-B connector 1. As shown in FIG. 1, the USB 3.0 standard-B connector 1 comprises a USB 2.0 standard-B plug 10 and a standard-B plug 12. In the convention, since the USB 2.0 standard-B plug 10 is undetachably connected to the standard-B plug 12, the USB 3.0 standard-B connector 1 cannot be connected to an electronic device equipped with a USB 2.0 standard-B receptacle only for purpose of data transmission or charge.

Referring to FIG. 2, FIG. 2 is a schematic diagram illustrating a conventional USB 3.0 micro-A connector 2. As shown in FIG. 2, the USB 3.0 micro-A connector 2 comprises a USB 2.0 micro-A plug 20 and a micro-A plug 22. In the convention, since the USB 2.0 micro-A plug 20 is undetachably connected to the micro-A plug 22, the USB 3.0 micro-A connector 2 cannot be connected to an electronic device equipped with a USB 2.0 micro-AB receptacle only for purpose of data transmission or charge.

Referring to FIG. 3, FIG. 3 is a schematic diagram illustrating a conventional USB 3.0 micro-B connector 3. As shown in FIG. 3, the USB 3.0 micro-B connector 3 comprises a USB 2.0 micro-B plug 30 and a micro-B plug 32. In the convention, since the USB 2.0 micro-B plug 30 is undetachably connected to the micro-B plug 32, the USB 3.0 micro-B connector 3 cannot be connected to an electronic device equipped with a USB 2.0 micro-B receptacle only for purpose of data transmission or charge.

As mentioned in the above, since the conventional USB 3.0 connector has undetachable plug structure, it cannot be connected to an electronic device equipped with a USB 2.0 standard-B, micro-AB or micro-B receptacle only. It is very inconvenient for users.

### SUMMARY OF THE INVENTION

Therefore, an objective of the preferred embodiment is to provide a USB connector with detachable USB plugs, so as to solve the aforesaid problems.

A USB connector of the preferred embodiment is adapted to a USB receptacle in compliance with a first USB standard and another USB receptacle in compliance with a second USB standard. The USB connector comprises a first USB plug and a second USB plug. The first USB plug is also in compliance with the first USB standard. The second USB plug integrated with the first USB plug is in compliance with a second USB standard different from the first USB standard. In this embodiment, the second USB plug is detachably connected to the first USB plug.

In practical applications, the first USB standard may be USB 2.0 standard, and the second USB standard may be USB 3.0 standard. For example, if the USB receptacle is a USB 2.0 standard-B receptacle, the first USB plug is a USB 2.0 standard-B plug, and the second USB plug integrated with the first USB plug is a USB 3.0 standard-B plug; if the USB receptacle is a USB 2.0 micro-B receptacle, the first USB plug is a USB 2.0 micro-B plug, and the second USB plug integrated with the first USB plug is a USB 3.0 micro-B plug; if the USB receptacle is a USB 2.0 micro-AB receptacle, the first USB plug is a USB 2.0 micro-B or micro-A plug, and the second USB plug integrated with the first USB plug is a USB 3.0 micro-B or micro-A plug.

Once an electronic device only has a USB 2.0 standard-B, micro-AB or micro-B receptacle, a user can detach the first USB plug from the second USB plug and then inserts the first USB plug (e.g. USB 2.0 standard-B, micro-A or micro-B plug) into the USB 2.0 receptacle correspondingly for purpose of data transmission or charge. Accordingly, it is very convenient for users.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional USB 3.0 standard-B connector.

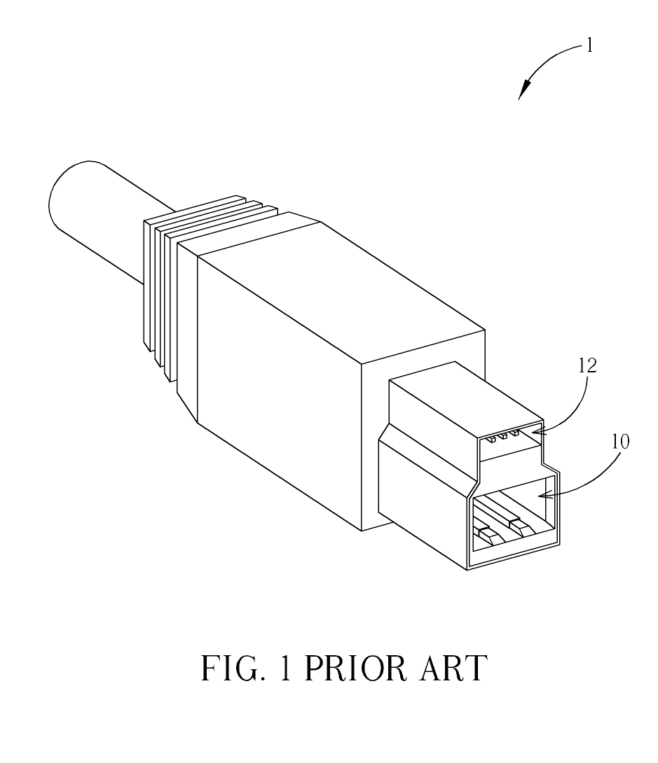

FIG. 2 is a schematic diagram illustrating a conventional USB 3.0 micro-A connector.

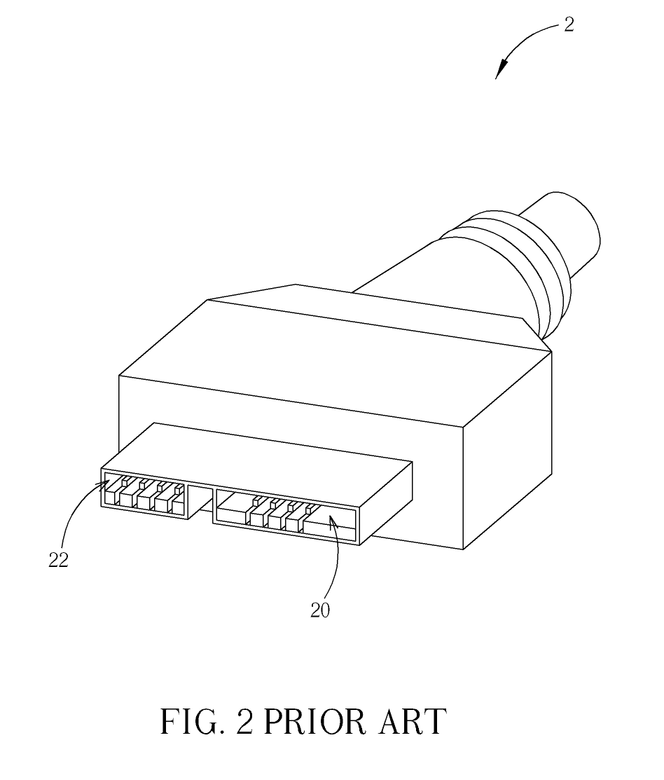

FIG. 3 is a schematic diagram illustrating a conventional USB 3.0 micro-B connector.

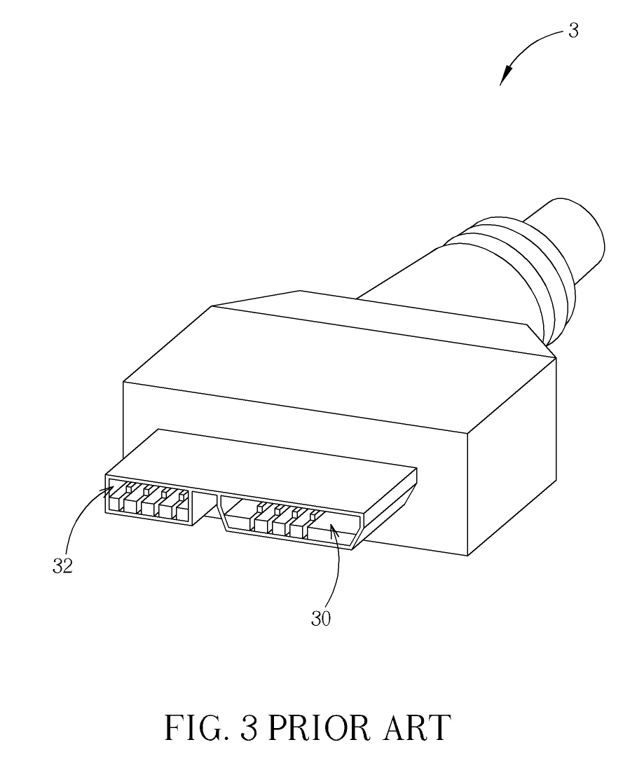

FIG. 4 is a schematic diagram illustrating a preferred embodiment of a USB connector.

FIG. 5 is an exploded view illustrating the USB connector shown in FIG. 4, wherein FIG. 5(A) is a perspective view and FIG. 5(B) is a side view.

FIG. 6 is an exploded view illustrating a USB connector according to another preferred embodiment, wherein FIG. 6(A) is a perspective view and FIG. 6(B) is a side view.

FIG. 7 is an exploded view illustrating a USB connector according to another preferred embodiment, wherein FIG. 7(A) is a perspective view and FIG. 7(B) is a side view.

FIG. 8 is a schematic diagram illustrating a USB connector according to another preferred embodiment, wherein FIG. 8(A) is an exploded view and FIG. 8(B) is an assembly view.

FIG. 9 is a schematic diagram illustrating a USB connector according to another preferred embodiment.

FIG. 10 is an exploded view illustrating the USB connector shown in FIG. 9, wherein FIG. 10(A) is a perspective view and FIG. 10(B) is a top view.

FIG. 11 is a schematic diagram illustrating a USB connector according to another preferred embodiment, wherein FIG. 11(A) is an exploded view and FIG. 11(B) is an assembly view.

### DETAILED DESCRIPTION

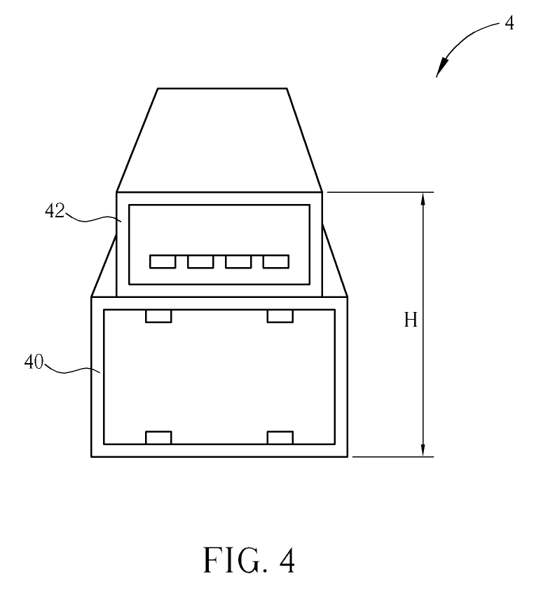

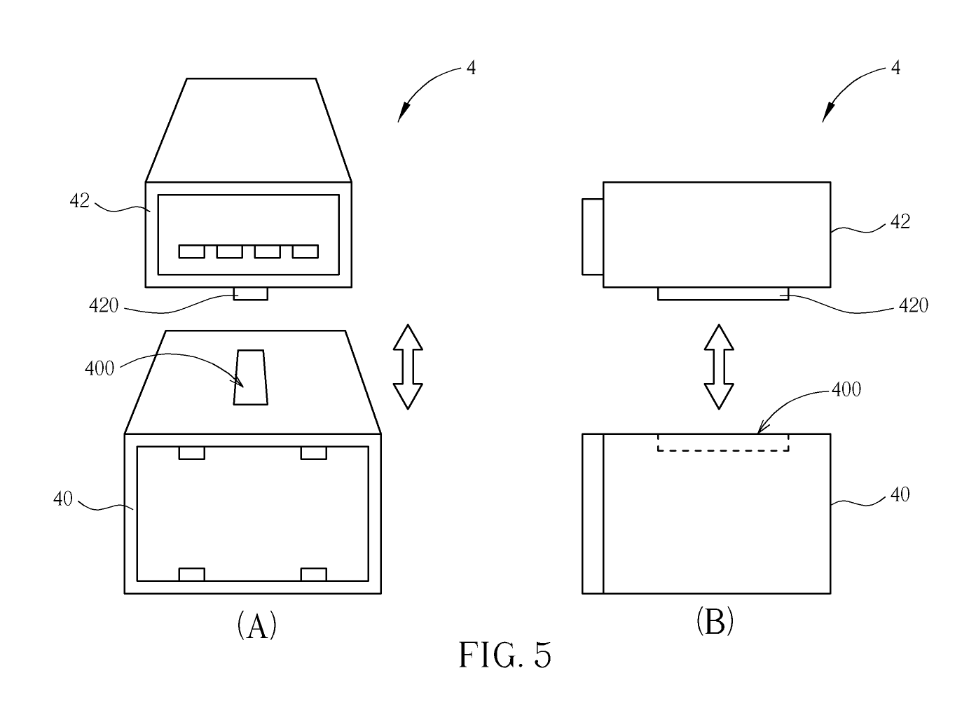

Referring to FIGS. 4 and 5, FIG. 4 is a schematic diagram illustrating a USB connector 4 according to one preferred embodiment, and FIG. 5 is an exploded view illustrating the USB connector 4 shown in FIG. 4, wherein FIG. 5(A) is a perspective view and FIG. 5(B) is a side view. As shown in FIGS. 4 and 5, the USB connector 4 comprises an independent first USB plug 40 and an independent second USB plug 42, wherein the first USB plug 40 is in compliance with a first USB standard, and the second USB plug 42 integrated with the first USB plug 40 is in compliance with a second USB standard different from the first USB standard.

In this embodiment, the first USB standard may be USB 2.0 standard and the second USB standard may be USB 3.0 standard. In practical applications, the first USB plug 40 may be a USB 2.0 standard-B plug, and the second USB plug 42 integrated with the first USB plug 40 may be a USB 3.0 standard-B plug.

As shown in FIGS. 4 and 5, the second USB plug 42 is detachably connected to the first USB plug 40. Accordingly, once an electronic device (not shown) only has a USB 2.0 standard-B receptacle, a user can detach the first USB plug 40 from the second USB plug 42 and then inserts the first USB plug 40 (i.e. USB 2.0 standard-B plug) into the USB 2.0 standard-B receptacle correspondingly for purpose of data transmission or charge. It should be noted that when the second USB plug 42 is connected to the first USB plug 40 in a stack manner as shown in FIG. 4, a sum of height H of the first and second plugs 40, 42 is equal to 10.44 mm, so as to be in compliance with USB 3.0 standard.

The two independent USB plugs can be connected to each other through various manners, so as to increase usage convenience. In this embodiment, the first USB plug 40 has a first engaging portion 400 and the second USB plug 42 has a second engaging portion 420. The first engaging portion 400 can be engaged with or disengaged from the second engaging portion 420. For example, when an electronic device has a USB 3.0 standard-B receptacle, a user can engage the second engaging portion 420 with the first engaging portion 400 to connect the first USB plug 40 and the second USB plug 42 and then inserts the USB connector 4 into the USB 3.0 standard-B receptacle correspondingly for purpose of data transmission or charge. On the other hand, when an electronic device only has a USB 2.0 standard-B receptacle, a user can disengage the second engaging portion 420 from the first engaging portion 400 to separate the first USB plug 40 and the second USB plug 42 and then inserts the first USB plug 40 (i.e. USB 2.0 standard-B plug) into the USB 2.0 standard-B receptacle correspondingly for purpose of data transmission or charge.

As shown in FIG. 5, the first engaging portion 400 may be an engaging groove and the second engaging portion 420 may be a tenon. However, in another embodiment, the first engaging portion 400 may be a tenon and the second engaging portion 420 may be an engaging groove. Furthermore, the shapes of the first and second engaging portions 400, 420 are not limited to rectangular form shown in FIG. 5 and may also be wedge-shaped, circular or other forms.

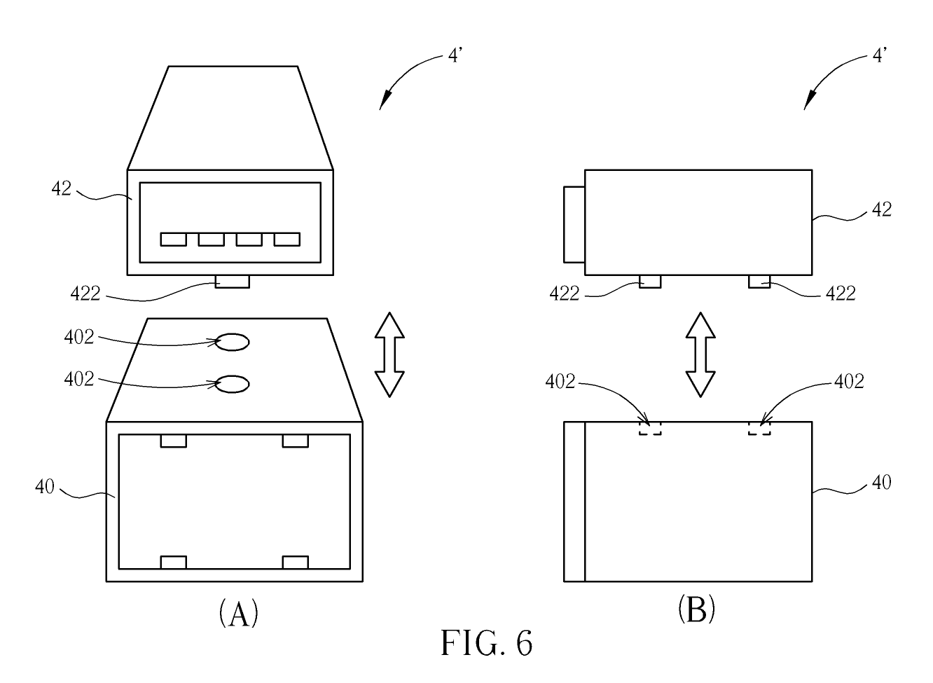

Referring to FIG. 6, FIG. 6 is an exploded view illustrating a USB connector 4′ according to another preferred embodiment, wherein FIG. 6(A) is a perspective view and FIG. 6(B) is a side view. As shown in FIG. 6, the first USB plug 40 has two first engaging portions 402 and the second USB engaging plug 42 has two second engaging portions 422. The two first engaging portions 402 can be engaged with or disengaged from the two second engaging portions 422 correspondingly. In other words, the number of the first and second engaging portions can be determined based on practical applications.

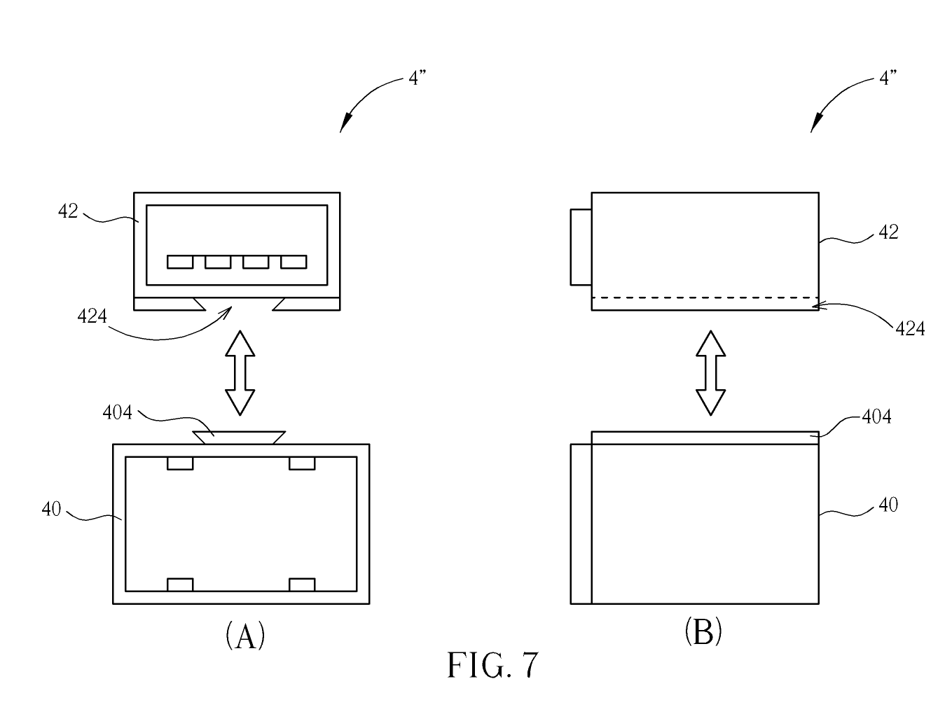

Referring to FIG. 7, FIG. 7 is an exploded view illustrating a USB connector 4″ according to another preferred embodiment, wherein FIG. 7(A) is a perspective view and FIG. 7(B) is a side view. As shown in FIG. 7, the first USB plug 40 has a wedge-shaped first engaging portion 404 (i.e. tenon) and the second USB plug 42 has a wedge-shaped second engaging portion 424 (i.e. engaging groove). The first engaging portion 404 can be engaged with or disengaged from the second engaging portion 424.

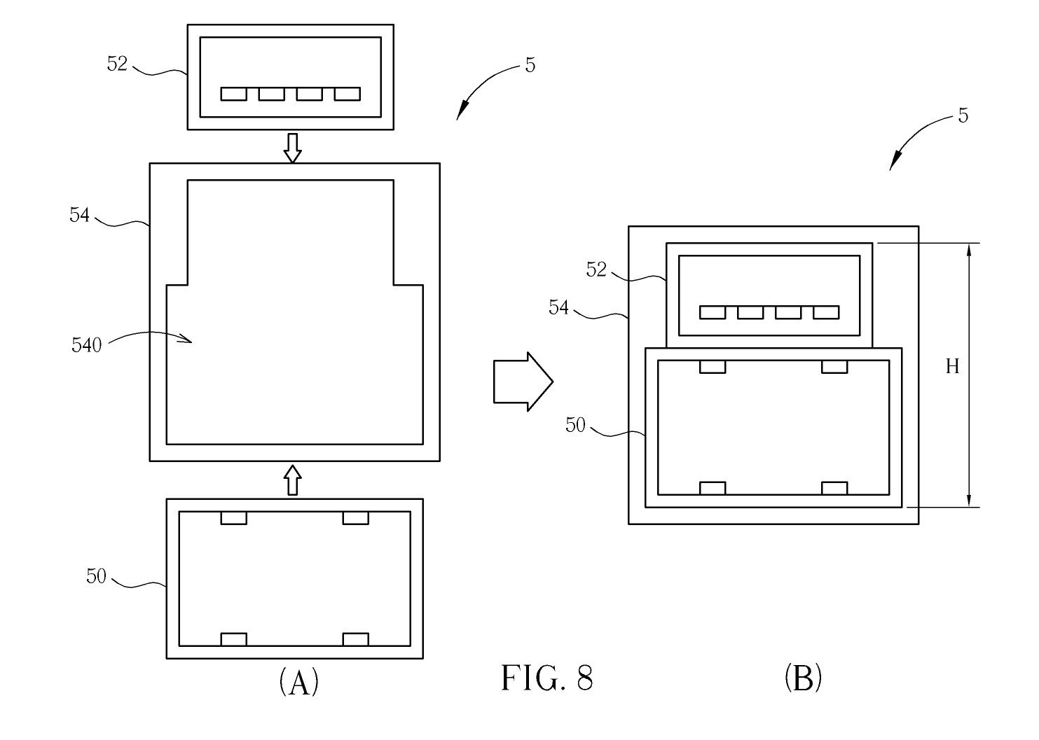

Referring to FIG. 8, FIG. 8 is a schematic diagram illustrating a USB connector 5 according to another preferred embodiment, wherein FIG. 8(A) is an exploded view and FIG. 8(B) is an assembly view. As shown in FIG. 8, the USB connector 5 comprises an independent first USB plug 50, an independent second USB plug 52 and a sheath 54. In this embodiment, the first USB plug 50 may be a USB 2.0 standard-B plug, and the second USB plug 52 integrated with the first USB plug 50 may be a USB 3.0 standard-B plug.

The sheath 54 has an accommodating space 540. When the second USB plug 52 is connected to the first USB plug 50, the first and second USB plugs 50, 52 can be accommodated in the accommodating space 540 together, as shown in FIG. 8(B). Once a user wants to use the first USB plug 50 independently, he or she only has to draw the first and second plugs 50, 52 out from the sheath 54 and then the first and second USB plugs 50, 52 are separated from each other consequently. The sheath 54 is used to connect the two independent first and second USB plugs 50, 52 and would not influence the connection between the USB connector 5 and corresponding receptacle. It should be noted that when the second USB plug 52 is connected to the first USB plug 50 in a stack manner as shown in FIG. 8(B), a sum of height H of the first and second plugs 50, 52 is equal to 10.44 mm, so as to be in compliance with USB 3.0 standard.

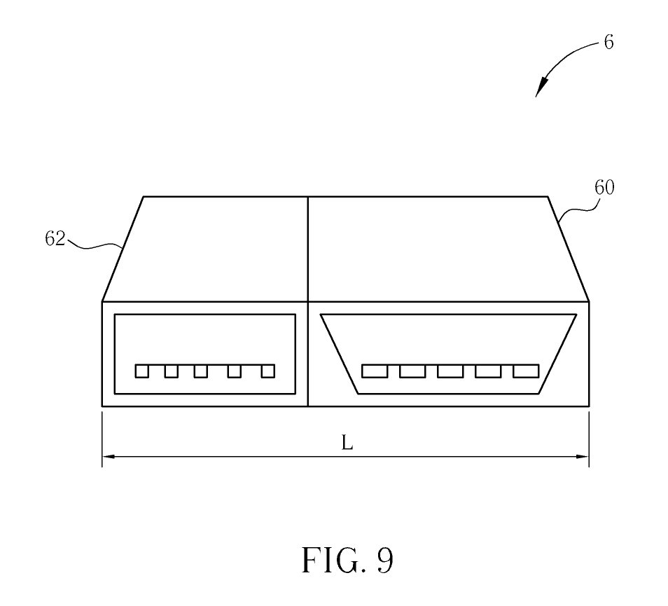

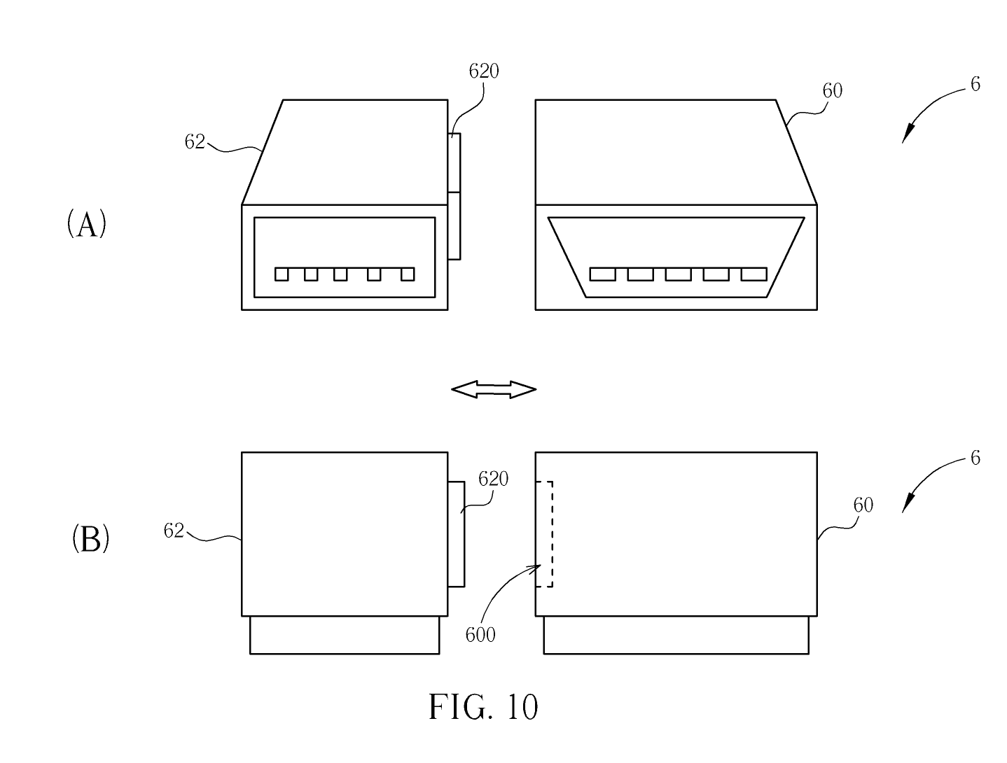

Referring to FIGS. 9 and 10, FIG. 9 is a schematic diagram illustrating a USB connector 6 according to another preferred embodiment, and FIG. 10 is an exploded view illustrating the USB connector 6 shown in FIG. 9, wherein FIG. 10(A) is a perspective view and FIG. 10(B) is a top view. As shown in FIGS. 9 and 10, the USB connector 6 comprises an independent first USB plug 60 and an independent second USB plug 62. In this embodiment, the first USB plug 60 may be a USB 2.0 micro-B plug, and the second USB plug 62 integrated with the first USB plug 60 may be a USB 3.0 micro-B plug.

As shown in FIGS. 9 and 10, the second USB plug 62 is detachably connected to the first USB plug 60. Accordingly, once an electronic device (not shown) only has a USB 2.0 micro-B receptacle, a user can detach the first USB plug 60 from the second USB plug 62 and then inserts the first USB plug 60 (i.e. USB 2.0 micro-B plug) into the USB 2.0 micro-B receptacle correspondingly for purpose of data transmission or charge. It should be noted that when the second USB plug 62 is connected to the first USB plug 60 in a parallel manner as shown in FIG. 9, a sum of length L of the first and second plugs 60, 62 is equal to 12.2 mm, so as to be in compliance with USB 3.0 standard.

In this embodiment, the first USB plug 60 has a first engaging portion 600 and the second USB plug 62 has a second engaging portion 620. The first engaging portion 600 can be engaged with or disengaged from the second engaging portion 620. The operation manner and structure design of the first and second engaging portions 600, 620 are similar to the aforesaid first and second engaging portions 400, 420, and the related description does not be depicted here again.

Moreover, the first USB plug 60 may also be a USB 2.0 micro-A plug adapted to a USB 2.0 micro-AB receptacle (not shown). The main difference between the USB 2.0 micro-A and micro-B plugs is the shape of opening, and the related description does not be depicted here again.

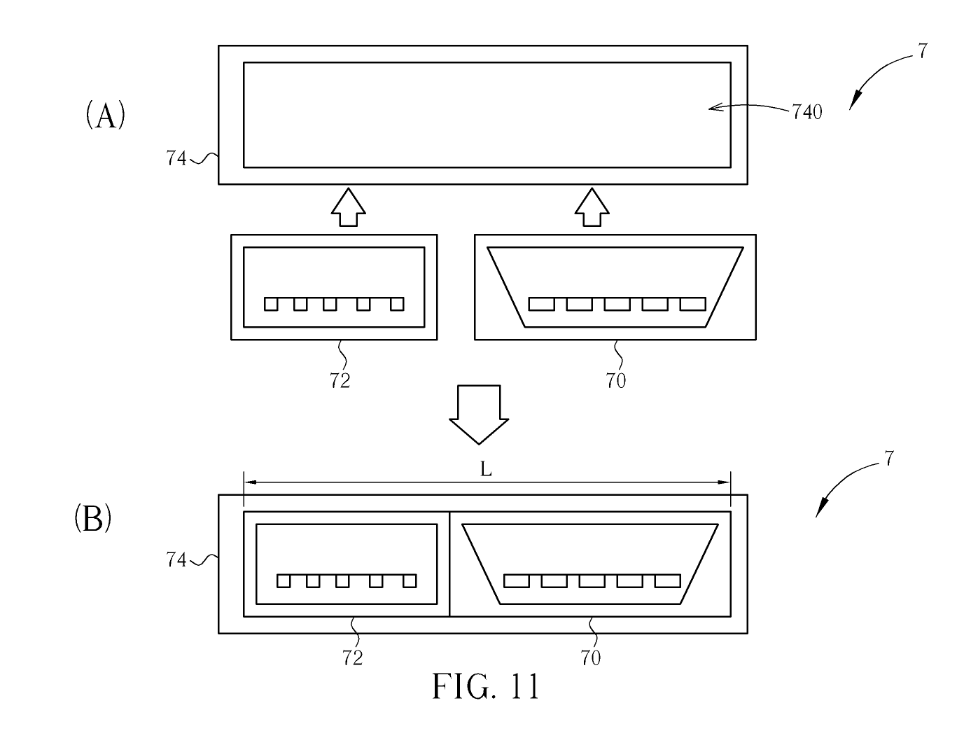

Referring to FIG. 11, FIG. 11 is a schematic diagram illustrating a USB connector 7 according to another preferred embodiment, wherein FIG. 11(A) is an exploded view and FIG. 11(B) is an assembly view. As shown in FIG. 11, the USB connector 7 comprises an independent first USB plug 70, an independent second USB plug 72 and a sheath 74. In this embodiment, the first USB plug 70 may be a USB 2.0 micro-B plug, and the second USB plug 72 integrated with the first USB plug 70 may be a USB 3.0 micro-B plug.

The sheath 74 has an accommodating space 740. When the second USB plug 72 is connected to the first USB plug 70, the first and second USB plugs 70, 72 can be accommodated in the accommodating space 740 together, as shown in FIG. 11(B). Once a user wants to use the first USB plug 70 independently, he or she only has to draw the first and second plugs 70, 72 out from the sheath 74 and then the first and second USB plugs 70, 72 are separated from each other consequently. The sheath 74 is used to connect the two independent first and second USB plugs 70, 72 and would not influence the connection between the USB connector 7 and corresponding receptacle. It should be noted that when the second USB plug 72 is connected to the first USB plug 70 in a parallel manner as shown in FIG. 11(B), a sum of length L of the first and second plugs 70, 72 is equal to 12.2 mm, so as to be in compliance with USB 3.0 standard.

According to the USB connector of the preferred embodiment, once an electronic device only has a USB 2.0 standard-B, micro-AB or micro-B receptacle, a user can detach the first USB plug from the second USB plug and then inserts the first USB plug (e.g. USB 2.0 standard-B, micro-A or micro-B plug) into the USB 2.0 receptacle correspondingly for purpose of data transmission or charge. Accordingly, it is very convenient for users.

Those skilled in the art will readily observe that numerous modifications and alterations of the device and method may be made while retaining the teachings of the invention.

1. A USB connector comprising:
a first USB plug which is compatible with both a first USB receptacle and a second USB receptacle of a host device for purpose of data transmission and charge according to a first USB standard; and
a second USB plug which is incompatible with either the first USB receptacle or the second USB receptacle of the host device for purpose of data transmission and charge but is capable of being detachably connected to the first USB plug to be compatible with the second USB receptacle of the host device for purpose of data transmission and charge according to a second USB standard different from the first USB standard.

2. The USB connector of claim 1, wherein the first USB standard is USB 2.0 standard, and the second USB standard is USB 3.0 standard.

3. The USB connector of claim 2, wherein the first USB plug is a USB 2.0 standard-B plug, and the second USB plug integrated with the first USB plug is a USB 3.0 standard-B plug.

4. The USB connector of claim 2, wherein the first USB plug is a USB 2.0 micro-B plug, and the second USB plug integrated with the first USB plug is a USB 3.0 micro-B plug.

5. The USB connector of claim 2, wherein the first USB plug is a USB 2.0 micro-A plug, and the second USB plug integrated with the first USB plug is a USB 3.0 micro-A plug.

6. The USB connector of claim 1, wherein the first USB plug has a first engaging portion, the second USB plug has a second engaging portion, and the first engaging portion of the first USB plug is detachably connected to the second engaging portion of the second USB plug.

7. The USB connector of claim 6, wherein the first engaging portion is a tenon and the second engaging portion is an engaging groove.

8. The USB connector of claim 7, wherein the tenon and the engaging groove are wedge-shaped.

9. The USB connector of claim 6, wherein the first engaging portion is an engaging groove and the second engaging portion is a tenon.

10. The USB connector of claim 9, wherein the tenon and the engaging groove are wedge-shaped.

11. The USB connector of claim 1, further comprising a sheath with an accommodating space for accommodating the first and second USB plugs when the second USB plug is connected to the first USB plug.

12. The USB connector of claim 1, wherein the second USB plug is connected to the first USB plug in a stack manner, a sum of height of the first and second USB plugs is equal to 10.44 mm.

13. The USB connector of claim 1, wherein the second USB plug is connected to the first USB plug in a parallel manner, a sum of length of the first and second USB plugs is equal to 12.2 mm.
